(19) United States
(12) Patent Application Publication
(10) Pub. No.: US 2025/0143233 A1
(43) Pub. Date: May 8, 2025

(54) CONTROLLING FLASH FLOODING IN SMART CITIES THROUGH CLOUD SEEDING AT STRATEGIC LOCATIONS

(71) Applicant: INTERNATIONAL BUSINESS MACHINES CORPORATION, ARMONK, NY (US)

(72) Inventors: Sarbajit K. Rakshit, Kolkata (IN); Jagabondhu Hazra, Bangalore (IN); Manikandan Padmanaban, Chennai (IN)

(21) Appl. No.: 18/500,266

(22) Filed: Nov. 2, 2023

(51) Int. Cl. A01G 15/00; G06Q 10/0635

(52) U.S. Cl. CPC A01G 15/00; G06Q 10/0635

(57) ABSTRACT

According to one embodiment, a method, computer system, and computer program product for flood mitigation is provided. The present invention may include detecting cloud formation; projecting a path of the formed cloud; determining a risk of a flood event in a city based on the projected cloud path and the detected cloud formation; performing a cost-benefit analysis based on the determined risk; and, based on the cost-benefit analysis, deploying cloud seeding at one or more regions.

### BACKGROUND

The present invention relates, generally, to the field of computing, and more particularly to smart flood management.

The field of smart flood management is concerned with the use of advanced technologies and data-driven approaches to effectively monitor, predict, mitigate, and respond to flooding events. Flooding is a significant natural disaster that can result in widespread damage to infrastructure, property, and even loss of life. Smart flood management leverages various technologies and strategies to enhance flood resilience and reduce the negative impacts of flooding.

### SUMMARY

According to one embodiment, a method, computer system, and computer program product for flood mitigation is provided. The present invention may include detecting cloud formation; projecting a path of the formed cloud; determining a risk of a flood event in a city based on the projected cloud path and the detected cloud formation; performing a cost-benefit analysis based on the determined risk; and, based on the cost-benefit analysis, deploying cloud seeding at one or more regions.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a flood prevention process according to at least one embodiment;

FIG. 3 illustrates an exemplary natural rainfall process; and

FIG. 4 illustrates an exemplary use case of a flood prevention process according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to smart flood management. The following described exemplary embodiments provide a system, method, and program product to, among other things, identify cloud formation and predict cloud travel path, estimate a risk of a flood event based on the predicted travel path, and trigger selective cloud seeding measures based on the risk.

As previously described, smart flood management is concerned with the use of advanced technologies and data-driven approaches to effectively monitor, predict, mitigate, and respond to flooding events. Flooding events, or floods, may be weather phenomena that occur, broadly speaking, when the amount of precipitation in a region significantly exceeds the absorptive capacity of the soil in that region. Modern cities and civil infrastructure compound the likelihood and severity of flood events in that the prevalence of non-permeable surfaces such as concrete sidewalks, asphalt roadways, metal and shingled roofs, et cetera significantly decrease the capacity of the local soil to absorb rainwater. Floods can cause significant damage to homes, businesses, infrastructure, and agriculture, and can result in injury and loss of life.

Flooding often occurs when moist air from an ocean or lake encounters a mountain range, and is forced to rise up and over the mountains; as the moist air rises, it cools, and its moisture condenses into clouds, leading to precipitation on the windward side of the mountain. This precipitation naturally flows downhill, gaining speed, and may cause flooding or even flash flooding if the volume and/or speed of the flowing water becomes significant enough. A flash flood is a sudden and rapid flooding caused by heavy rainfall, often in a short period. Flash floods can be very dangerous and destructive, as they can occur with little or no warning and can rapidly inundate an area.

Cloud seeding is a technology whereby the amount of precipitation that falls from clouds may be modified by dispersing substances into the air that serve as cloud condensation or ice nuclei, which alter the microphysical processes within the cloud. The most common chemicals used for cloud seeding may include silver iodide, potassium iodide, and dry ice. These chemicals may be dispersed by aircraft or by ground-based dispersion devices, such as rockets or launchers. Once dispersed within a cloud, the seeding chemicals aid in the formation of ice crystals, which then descend and melt to become rain.

Satellite imagery may be used to predict cloud formation in a region, and weather data may be used to predict the trajectory of these newly formed clouds and the volume of rainfall they will produce when encountering a mountain. As such, it may be advantageous to, among other things, implement a system that utilizes satellite imagery and weather data to predict cloud formation, trajectory, and volume of rainfall, and based on the predicted volume of rainfall on a mountain or city, determine a risk of a flood event; it may be further advantageous to implement a system which, based on the risk level, triggers the performance of selective cloud seeding on the clouds before they reach the mountain, to reduce the total volume of mountain rainfall and thereby reduce the risk of flooding. Therefore, the present embodiment has the capacity to improve the technical field of smart flood management by leveraging sensor data to intelligently trigger cloud seeding at a location and time formulated to improve rainfall in desired areas to improve irrigation, dust settlement, et cetera, and minimize the cost of cloud seeding by maximizing the effect; the present embodiment further has the capacity to reduce excessive rainfall in mountainous or inhabited areas, thereby preventing dangerous floods and mitigating the risk of flood damage to life and property.

According to at least one embodiment, the invention may be a system which uses the combination of geo-location, topography, historical flash flood information, and satellite observations (optical/microwave spectrum) to monitor the spatio-temporal distribution of cloud formation and predict the cloud movement towards mountains, and estimates the risk of flash flood on a city's critical infrastructure, leveraging the city's infrastructure layout map and its impact and based on the flood risk level, proactively diffuses the selective clouds on the plain through selective cloud seedings at the required locations and minimizes the risk of flash flood.

In embodiments, the invention may include performing a cost-benefit analysis to determine an optimal set of locations for pro-active cloud seeding by considering the trade-off between the cost incurred in deploying cloud seeding and impact of the predicted flash flood on the critical infrastructures of smart cities.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The following described exemplary embodiments provide a system, method, and program product to identify cloud formation and predict cloud travel path, estimate a risk of a flood event based on the predicted travel path, and trigger selective cloud seeding measures based on the risk.

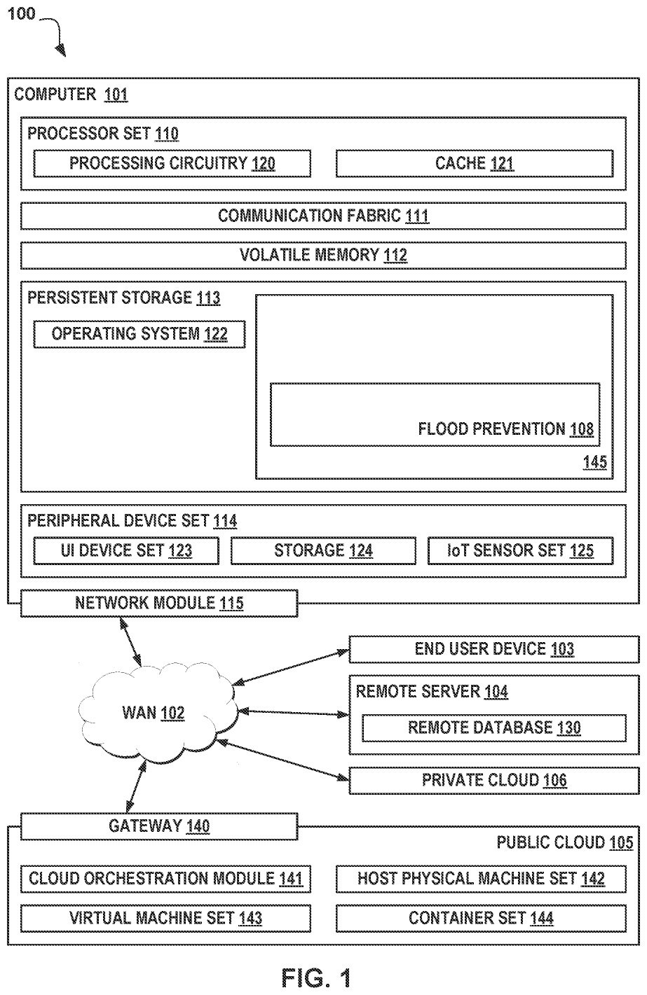

Referring now to FIG. 1, computing environment 100 contains an example of an environment for the execution of at least some of the computer code involved in performing the inventive methods, such as code block 145, which may comprise flood prevention program 108. In addition to code block 145, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and code block 145, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in code block 145 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in code block 145 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, sensors of sensor set 125 may comprise meteorological sensors, cameras, et cetera capable of gathering data relevant to identifying and predicting cloud formation and movement deployed within a region.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

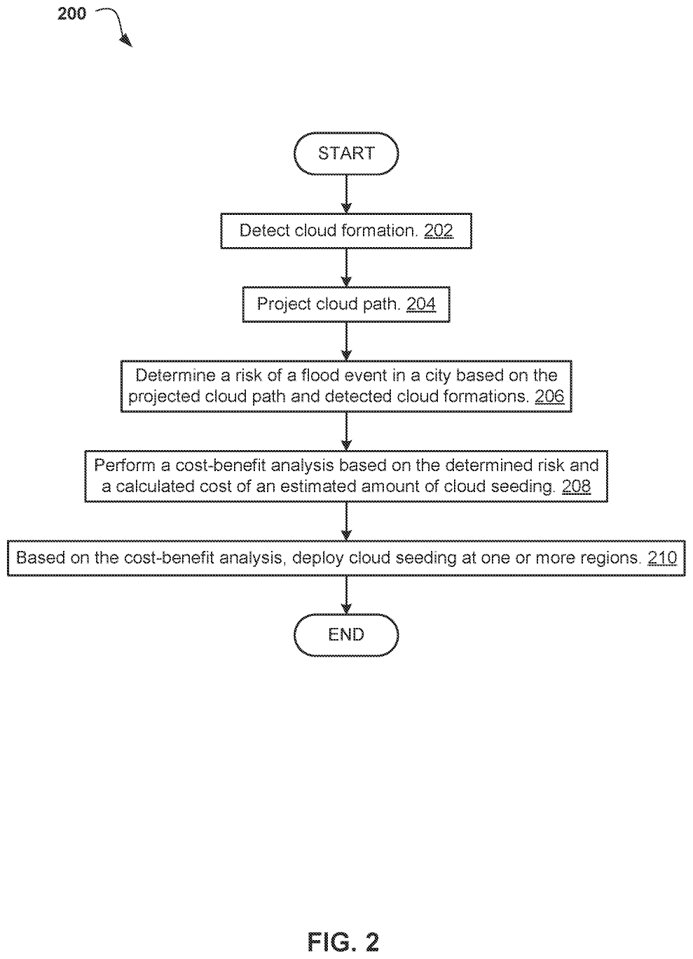

According to the present embodiment, the flood prevention program 108 may be a program enabled to identify cloud formation and predict cloud travel path, estimate a risk of a flood event based on the predicted travel path, and trigger selective cloud seeding measures based on the risk. The flood prevention program 108 may, when executed, cause the computing environment 100 to carry out a flood prevention process 200. The flood prevention process 200 may be explained in further detail below with respect to FIG. 2. In embodiments of the invention, the flood prevention program 108 may be stored and/or run within or by any number or combination of devices including computer 101, end user device 103, remote server 104, private cloud 106, and/or public cloud 105, peripheral device set 114, and server 112 and/or on any other device connected to WAN 102. Furthermore, flood prevention program 108 may be distributed in its operation over any number or combination of the aforementioned devices.

Referring now to FIG. 2, an operational flowchart illustrating a flood prevention process 200 is depicted according to at least one embodiment. At 202, the flood prevention program 108 may detect cloud formation. In embodiments, flood prevention program 108 may use and satellite observations (optical/microwave spectrum) and visual and/or meteorological sensor data from aerial or ground-based sensor platforms to monitor cloud formation in a region. The flood prevention program 108 may supplement this sensor data with a combination of geo-location, topography, historical cloud formation data, meteorological models/simulations, machine learning models trained on meteorological data to predict cloud formation, et cetera to improve the accuracy of cloud formation predictions and weather forecasts. Once a cloud forms and exceeds a certain size threshold, the flood prevention program 108 may analyze the cloud's size, color, altitude, shape, and meteorological conditions of the cloud's formation to estimate an amount of precipitation that the cloud is capable of producing. In embodiments, the flood prevention program 108 may dynamically update this precipitation estimation at regular intervals, such as every hour or every day, and/or after events such as observed rainfall from the cloud, changes in the cloud's size or volume, successful cloud seeding operations, et cetera.

At 204, the flood prevention program 108 may project the cloud path. The flood prevention program 108 may estimate the flowing direction of the cloud from the place of its formation; the flood prevention program 108 may project the cloud path by analyzing the cloud's position in successive images and extrapolating a path for the cloud therefrom; the flood prevention program 108 may augment the cloud path prediction with historical data regarding historical cloud movement in the region, and historical weather/environmental factors in the region that affect cloud formation and movement. The flood prevention program 108 may use meteorological and sensor data to identify the current weather conditions, such as wind, humidity, pressure differentials, et cetera, that may influence the movement of the cloud in the region. In embodiments, for example where the flood prevention program 108 predicts that the cloud's path will carry the cloud over a mountain, the flood prevention program 108 may predict an altitude that the cloud may reach when encountering the mountain at which the cloud will release precipitation. In embodiments, the flood prevention program 108 may dynamically re-assess the path prediction at regular intervals, such as every hour or every day, and/or after events such as significant changes in wind or weather, successful cloud seeding operations, et cetera, and may likewise reassess whether the cloud's path will carry the cloud over a mountain and what altitude the cloud may reach as a result.

At 206, the flood prevention program 108 may determine a risk of a flood event in a city based on the projected cloud path and detected cloud formations. The flood prevention program 108 may consider the previously determined amount of precipitation, in terms of weight, that the cloud is estimated to produce, as well as the predicted altitude of the cloud on the mountain, to determine a stored potential energy of the rainwater; the stored potential energy may be a function of the amount of water and the height above sea level at which the water is deposited on the mountain, and may represent the amount of energy that the water is capable of exerting as it flows downhill. Based on this stored potential energy, the flood prevention program 108 may estimate a speed and volume of the precipitated moisture; the flood prevention program 108 may further assess the ability of a city located on or near a mountain and downhill of and/or in the path of the flowing precipitation, as well as, in some embodiments, any intervening terrain between the city and the precipitation, to absorb rainwater based on soil moisture level and absorbency of ground surfaces. The flood prevention program 108 may assess the flow of the rainwater through the city based on the topology of the city and surrounding terrain, the flood prevention infrastructure present in the city such as drains and overflow channels, the distance between the mountain and the city, et cetera. The flood prevention program 108 may thereby determining where and how far the precipitation may travel. The flood prevention program 108 may assess a level of damage that the precipitation is capable of causing to the city based on a vulnerability of the city, which may be calculated based on the volume and flow of precipitation over the terrain and through the city. The flood prevention program 108 may assess the vulnerability of the city to the precipitation flowing down the mountainside based on the location and structural strength of one or more elements of critical infrastructure within the city. Critical infrastructure may include agricultural land, civic buildings, bridges, residences, industrial facilities, et cetera. The flood prevention program 108 may assess how well any given element of critical infrastructure may withstand the predicted volume and speed of the precipitated moisture, based on the structural strength of its component materials and design, as well as its location relative to other structures and terrain features, and may determine which, how many, and how severely elements of critical infrastructure are threatened as a result in determining the vulnerability. Based on this vulnerability to the predicted rainfall, the flood prevention program 108 may calculate a risk to the city posed by the precipitation, where the risk represents the overall likelihood that the predicted precipitation will be sufficient to damage critical infrastructure in the city, and therefore constitute a flood event. In embodiments, the risk may alternately or additionally reflect a predicted scope and severity of damage to critical infrastructure from a flood event, for example such that even where the probability of a flood event is low the risk may still be high if the potential damage to critical infrastructure is significant if the flood event occurs. In embodiments, the flood prevention program 108 may dynamically recalculate the risk at regular intervals such as every half hour, hour, day, et cetera, and/or after events such as successful seeding operations, observed rainfall from the cloud, changes in the predicted path and/or altitude of the cloud, et cetera.

At 208, the flood prevention program 108 may perform a cost-benefit analysis based on the determined risk and a calculated cost of an estimated amount of cloud seeding. The flood prevention program 108 may estimate a required amount of cloud seeding necessary for the cloud; in other words, the flood prevention program 108 may determine, based on, for example, the size, volume, altitude et cetera of the cloud, an amount of seeding chemical, such as silver iodide, that will be necessary to induce rainfall in the cloud sufficient to reduce the amount of predicted rainfall, and therefore the risk of flooding, below the risk threshold. The flood prevention program 108 may calculate a cost of the estimated amount of cloud seeding, for example by estimating a cost of cloud seeding chemicals required to achieve the determined amount of cloud seeding, as well as the fuel and operational costs required to deploy a cloud seeding platform to the site of the cloud, such as via a cloud seeding aircraft or ground-based launcher system and transport vehicle. The flood prevention program 108 may calculate fuel and operational costs based on the cloud's distance from available cloud-seeding platforms, the type and operating/maintenance costs of cloud-seeding equipment available, the cost and availability of personnel trained to pilot, operate, or navigate the cloud-seeding equipment, and the hours required of them, et cetera. In embodiments, the flood prevention program 108 may compare the cost against the risk, and, based on one or more user-provided rules, determine whether the risk exceeds the cost, or exceeds/falls short of the cost by a user-provided margin. In embodiments, the flood prevention program 108 may present the determined cost and risk to a human user using a graphical prompt displayed on an end user device 103, and receive the human user's decision on whether to initiate cloud seeding. In embodiments, the flood prevention program 108 may evaluate several types or combinations of cloud-seeding platforms to determine operational costs, and may present multiple options for cloud-seeding operations to a human user for selection ranked by cost and/or other factors such as speed of deployment, environmental impact, likelihood of success, et cetera, and may initiate cloud seeding based on receiving the user's response and chosen course of action. In some embodiments, the flood prevention program 108 may automatically choose the option with the lowest cost, the highest effectiveness, and/or the lowest environmental impact.

In embodiments, the flood prevention program 108 may perform an environmental benefit analysis as part of the cost-benefit analysis. In an exemplary embodiment, the flood prevention program 108 may calculate, given the N grid of identified spatial hotspots of flooding event risk, a set ‘j’ of spatial hotspots selected for cloud seeding such that the risk of a flooding event will be minimized, by increasing the environmental benefits such as irrigation, dust settlement, fencing of critical infrastructure from flash floods, et cetera, and by minimizing the overall cost of deploying equipment for the purpose of cloud seeding. The flood prevention program 108 may utilize the following function: J=Max.

$$J = Max \cdot {\sum }_{j = 1}^{N} {u}_{j} \{ {w}_{seq} \cdot {E}_{seq , j} - {w}_{D} \cdot {C}_{j} \}$$

Where J represents a cost function, uⱼ represents a binary decision variable (optimal identified hotspot pixel ‘j’), E_{seq,j} represents an increase in environmental benefits at pixel ‘j,’ C; represents a cost of deploying dispersal platforms with optimal cloud seeding at pixel ‘j,’ and where W_{seq}. W_{D} represents a weighing coefficient for environmental benefits by preventing flooding events and the expense for cloud seeding, respectively. The flood prevention program 108 may further calculate an environmental benefit or cost savings caused by executing cloud seeding at particular locations, such as by seeding clouds over agricultural zones, forests, areas requiring dust mitigation such as construction sites, et cetera.

At 210, the flood prevention program 108 may, based on the cost-benefit analysis, deploy cloud seeding at one or more regions. Here, the flood prevention program 108 may deploy cloud seeding if the cost-benefit analysis determines that the benefits of cloud seeding outweigh the costs, and/or outweigh the cost by a threshold value, based on the assessment of a human user transmitted to flood prevention program 108 in response to the courses of action proposed by flood prevention program 108. The flood prevention program 108 may deploy cloud seeding by communicating with a human user to alert the user to initiate cloud seeding, by deploying a specified number and type of cloud seeding deployment platforms to a specified location at a specified time. The flood prevention program 108 may identify one or more aircraft and/or other deployment options such as ground-based launchers from a pre-provided list of available options based on the required amount of cloud seeding, the location and trajectory of the cloud, and/or the capabilities of the deployment options, such as capacity and type of seeding chemical payload, speed, current location, current fuel, operating costs, et cetera. In embodiments, for example where one or more of the cloud seeding deployment platforms may be remotely controlled by flood prevention program 108, flood prevention program 108 may remotely operate one or more of the cloud seeding deployment platforms to execute the cloud seeding mission. In embodiments, the flood prevention program 108 may execute or direct human users or systems to execute cloud seeding missions at particular locations where an environmental benefit may be realized.

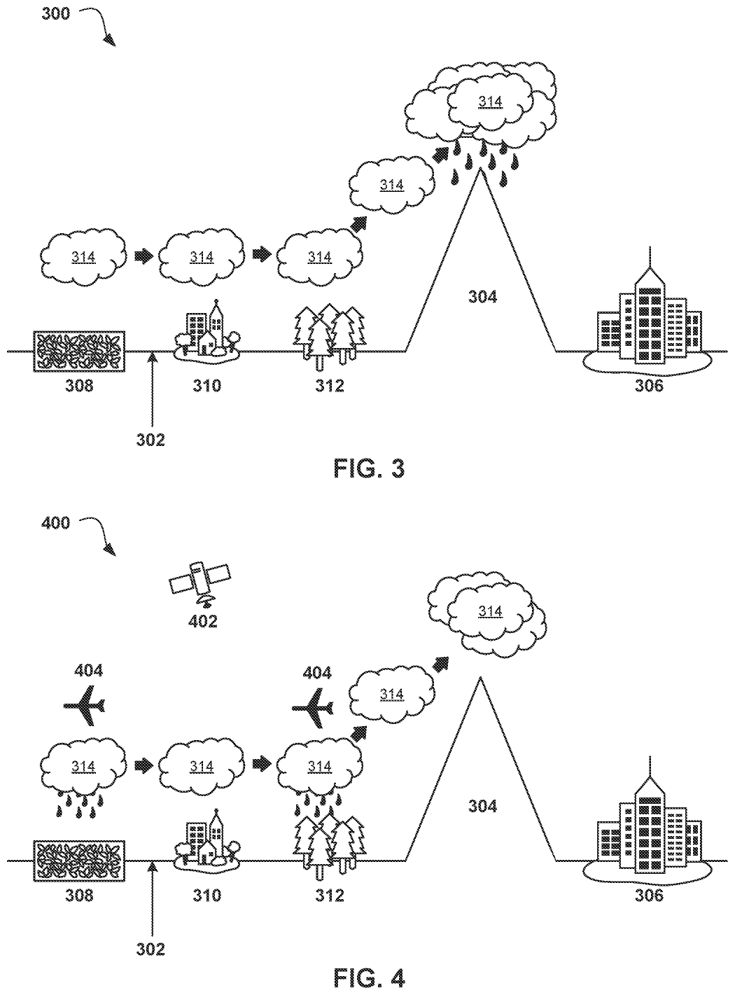

Referring now to FIG. 3, an example of a natural rainfall process 300 is illustrated. Here, the terrain comprises a flat plain 302 giving way to a mountain 304, on the other side of which is a city 306. The plain 302 comprises three locations: an agricultural field 308, a town 310, a forest 312. A cloud 314 forms in the plain 302 and travels over each location before encountering the mountain and rising to a particular altitude, before it drops its precipitation on the mountain 304. The water rolls down the mountain, and causes flash flooding in city 306.

Referring now to FIG. 4, an exemplary use case 400 of a flood prevention process 200 is illustrated according to at least one embodiment. Here, flood prevention program 108 uses a satellite 402 to collect satellite imaging data on the plain 302, the mountain 304, the city 306, and the cloud 314. The city 306 is located on the slopes of the mountain 304, and is therefore vulnerable to rainwater falling on the mountain at higher altitudes. The flood prevention program 108 detects the formation of cloud 314 over plain 302, and detects its trajectory. Upon determining that cloud 314's trajectory carries the cloud 314 towards the mountain, flood prevention program 108 determines a risk of a flood event in city 306 posed by the cloud 314. Upon determining that the risk of a flood in city 306 exceeds a threshold level, the flood prevention program 108 may identify the need for cloud seeding, and may perform a cost-benefit analysis on potential cloud seeding options. The flood prevention program 108 may, through the cost benefit analysis, identify that seeding the cloud 314 to produce rainfall at agricultural zone 308 would yield an economic benefit by improving crop growth. The flood prevention program 108 may further identify that seeding the cloud 314 to produce rainfall at forest 312 would yield an environmental benefit by improving the health of the forest 312. Accordingly, flood prevention program 108 may operate two aircraft 404 to deploy cloud seeding chemicals within cloud 314 when it is first present over agricultural zone 308, and then again when it is over forest 312. As a result of the cloud seeding, the cloud 314 is depleted of precipitation when it reaches mountain 304, and does not produce enough rainfall to threaten city 306 with a flood event.

It may be appreciated that FIGS. 2-4 provide only illustrations of individual implementations and do not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for flood mitigation, the method comprising:
detecting cloud formation;
projecting a path of the formed cloud;
determining a risk of a flood event in a city based on the projected cloud path and the detected cloud formation;
performing a cost-benefit analysis based on the determined risk; and
based on the cost-benefit analysis, deploying cloud seeding at one or more regions.

2. The method of claim 1, wherein the cost-benefit analysis is based on a calculated cost of an estimated amount of cloud seeding required based on the determined risk.

3. The method of claim 1, wherein the one or more regions are determined based on the cost-benefit analysis, and the one or more regions comprise locations where rainfall would yield an economic or environmental benefit.

4. The method of claim 1, wherein the cloud seeding is deployed by selecting one or more cloud seeding platforms from a pre-provided list based on the cost-benefit analysis.

5. The method of claim 1, responsive to determining that the cloud will reach a mountain based on the projected cloud path, identifying an altitude at which the cloud will release precipitation.

6. The method of claim 1, wherein the risk of a flood event is based on one or more locations of critical infrastructure within the city.

7. The method of claim 1, wherein the cloud path projection, cloud formation detection, and risk of a flood event are based on historical information.

8. A computer system for flood mitigation, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
detecting cloud formation;
projecting a path of the formed cloud;
determining a risk of a flood event in a city based on the projected cloud path and the detected cloud formation;
performing a cost-benefit analysis based on the determined risk; and
based on the cost-benefit analysis, deploying cloud seeding at one or more regions.

9. The computer system of claim 8, wherein the cost-benefit analysis is based on a calculated cost of an estimated amount of cloud seeding required based on the determined risk.

10. The computer system of claim 8, wherein the one or more regions are determined based on the cost-benefit analysis, and the one or more regions comprise locations where rainfall would yield an economic or environmental benefit.

11. The computer system of claim 8, wherein the cloud seeding is deployed by selecting one or more cloud seeding platforms from a pre-provided list based on the cost-benefit analysis.

12. The computer system of claim 8, responsive to determining that the cloud will reach a mountain based on the projected cloud path, identifying an altitude at which the cloud will release precipitation.

13. The computer system of claim 8, wherein the risk of a flood event is based on one or more locations of critical infrastructure within the city.

14. The computer system of claim 8, wherein the cloud path projection, cloud formation detection, and risk of a flood event are based on historical information.

15. A computer program product for flood mitigation, the computer program product comprising:
one or more computer-readable tangible storage medium and program instructions stored on at least one of the one or more tangible storage medium, the program instructions executable by a processor to cause the processor to perform a method comprising:
detecting cloud formation;
projecting a path of the formed cloud;
determining a risk of a flood event in a city based on the projected cloud path and the detected cloud formation;
performing a cost-benefit analysis based on the determined risk; and
based on the cost-benefit analysis, deploying cloud seeding at one or more regions.

16. The computer program product of claim 15, wherein the cost-benefit analysis is based on a calculated cost of an estimated amount of cloud seeding required based on the determined risk.

17. The computer program product of claim 15, wherein the one or more regions are determined based on the cost-benefit analysis, and the one or more regions comprise locations where rainfall would yield an economic or environmental benefit.

18. The computer program product of claim 15, wherein the cloud seeding is deployed by selecting one or more cloud seeding platforms from a pre-provided list based on the cost-benefit analysis.

19. The computer program product of claim 15, responsive to determining that the cloud will reach a mountain based on the projected cloud path, identifying an altitude at which the cloud will release precipitation.

20. The computer program product of claim 15, wherein the risk of a flood event is based on one or more locations of critical infrastructure within the city.
